(19) United States
(12) Patent Application Publication
(10) Pub. No.: US 2011/0133986 A1
(43) Pub. Date: Jun. 9, 2011

(54) DIRECTIONAL MULTIPLE-POLARIZATION WIDE BAND ANTENNA NETWORK

(76) Inventors: Anthony Bellion, Villefranche (FR); Cyrille Le Meins, Angers (FR)

(21) Appl. No.: 12/809,547

(22) PCT Filed: Dec. 19, 2008
(86) PCT No.: PCT/EP2008/068090

§ 371 Date: Feb. 22, 2011

(30) Foreign Application Priority Data
Dec. 21, 2007 (FR) 0709050

(51) Int. Cl. H01Q 21/24

(52) U.S. Cl. 342/362; 343/893

(57) ABSTRACT

A directional multiple-polarization wide band antenna array working in a selected frequency band and including a plurality of N individual sensors of convoluted spiral type complementing a number of strands arranged according to a structure making it possible to obtain for obtaining a given azimuth coverage, each of the N sensors including a reflecting plane attached to the antenna by an insulating spacer E, matching cells suited to the working frequency band of said array, and separate output channels (5) and (7) for the vertically-polarized signals and for the horizontally-polarized signals. The antenna array also including a device suitable for executing a direction-finding algorithm that uses the amplitude and the phase of said signals and is matched to the configuration of the array.

### CROSS REFERENCE TO RELATED APPLICATIONS

This is a U.S. National Phase Application under 35 U.S.C. §371 of International Application no. PCT/EP2008/068090, filed Dec. 19, 2008, and claims benefit of French Patent Application No. 07 09050, filed Dec. 21, 2007, both of which are incorporated herein.

### FIELD OF THE INVENTION

The invention relates to an architecture for an array of multiple-polarization wide band antennas and specifically to an array related to a frequency range comprising the very high frequency VHF (from 30 MHz to 300 MHz), the ultra high frequency UHF (from 300 MHz to 3 GHz) and the SHF frequency band (from 3 GHz to 30 GHz).

### BACKGROUND OF THE INVENTION

One of the main problems encountered when integrating direction-finding antennas is the choice of the mechanical structure holding the individual antennas and the positioning of the complete antenna system on a carrier structure. In practice, this placement is strategic because the antenna array must not be disturbed by the securing structure. This issue is accentuated in a multiple-polarization context.

For example, in the case of naval direction-finding, the choice of the positioning of the antenna is crucial and limited because of the many onboard equipment items such as radars, communication transmitters, navigation system, etc. An antenna system consisting of a number of directional antennas can be placed much more easily, for example around a mast. Because of its directional radiation, the performance levels of the antennas are therefore not penalized by the carrier structure.

In the field of radio direction-finding, most existing antenna systems operate only in vertical polarization mode. During the last two years, new antenna system designs have emerged and make it possible, a priori, to provide direction-finding for the vertically and horizontally polarized signals either separately or in a coupled manner by using a suitable direction-finding processing operation. These new systems use individual antennas with loop- or dipole-type omnidirectional azimuth radiofrequency coverage.

The main drawbacks to direction-finding antenna systems consisting of vertically and horizontally polarized omnidirectional antennas are notably:
that their performance levels depend on the mechanical structure securing the individual antennas and/or the carrier structure of the complete antenna system, and do so according to the polarization of the signals,
that a calibration phase with the carrier structure is necessary in order to approach optimum performance levels and to take account of the disturbances generated by the mechanical structure securing the individual antennas and/or the carrier structure of the complete antenna system. In some cases, the implementation of a calibration phase demands considerable resources which results in high integration costs or makes technical implementation impossible.

For multiple-polarization applications, there are currently various types of directional individual antennas. In the case of so-called “wide band” applications, spiral-type antennas with linear or circular bi-polarizations are used. An exemplary antenna is described in the European patent EP 0 198 578. This patent discloses an antenna with double circular polarization, comprising a number N of identical antenna branches, of convoluted overall shape, extending outward from a common central axis and that are arranged symmetrically on a surface at intervals of 360°/N about the central axis. Each antenna branch comprises cells of bends, lines and curves that are arranged in a log-periodic or quasi-log-periodic manner, so that each cell is inserted between adjacent cells of an adjacent antenna branch without touching these adjacent cells. The technical teaching of this patent is primarily access to the individual directional antenna and various embodiments for said antenna. It does not describe how to associate a number of antennas in order to produce multiple-polarization direction-finding or the type of processing to be used. Also, this patent describes the use of a cavity containing an electromagnetic absorbent material to make the antennas directional.

The antenna architecture or antenna array according to the invention relies on an association of a number of individual antennas arranged according to a selected structure and matched to the carrier structure in order to obtain a given azimuth radiofrequency coverage, for example over 360° with antennas that are directional or made directional by virtue of suitable elements. This invention can also be used in the case where a lesser angular coverage (over 180° for example) is desired and be used in detection systems where 360° coverage is not mandatory.

Also, depending on the type of carrier, the antenna processing operation used may vary and be matched to the performance levels targeted by an application.

### SUMMARY OF THE INVENTION

The present invention is used in the field of direction-finding antennas and makes it possible in a direction-finding context to process signals of various polarizations without interaction with the carrier through the use of suitable direction-finding processing operations. In practice, in certain installation configurations, the use of directional antennas provides for independence from the carrier structure. For example, in a naval direction-finding context, the antenna array according to the invention can be placed anywhere on the mast of a boat because of its directional radiation, without being disturbed by the latter.

In an embodiment, the invention provides a directional multiple-polarization wide band antenna array working in a selected frequency band that comprises at least the following elements:
N individual sensors of convoluted spiral type complementing a number of strands arranged according to a structure making it possible to obtain a given azimuth coverage,
each of the N sensors comprising a reflecting plane attached to the antenna by an insulating spacer E,
each of the N sensors comprising matching cells suited to the working frequency band of said array,
each of the N sensors comprising separate output channels for the vertically-polarized signals and for the horizontally-polarized signals,
a device suitable for executing a direction-finding algorithm that uses the amplitude and the phase of said signals and is matched to the configuration of the array.

According to one embodiment, the antenna array comprises:
means making it possible to group together the signals having one and the same polarization, on the one hand the vertically-polarized signals coming from the various individual sensors and on the other hand the horizontally-polarized signals,
a device suitable for executing a direction-finding algorithm that uses the amplitude and the phase of said grouped signals matched to the configuration of the array.

The azimuth radiofrequency coverage is, for example, around 360° and may be dependent on the carrier on which the antenna array is arranged.

### BRIEF DESCRIPTION OF THE DRAWINGS

Other features and advantages of the present invention will become more apparent from reading the following description of a detailed example given as a nonlimiting illustration, with appended figures which represent:

FIG. 1, an antenna element associated with a reflector according to the invention,

FIG. 2, a configuration of the 4 strands at the center of the individual antenna,

FIG. 3, an impedance matching system,

FIG. 4, an exemplary configuration of the antenna system according to the invention in the case of a 5-antenna array,

FIG. 5, a measured radiation pattern result for an antenna array according to the invention in vertical and horizontal polarization,

FIG. 6, an exemplary positioning of the antenna array at the top of a mast according to the invention, and

FIGS. 7 and 8, curves of effective height showing the gain obtained with the antenna array according to the invention and obtained with conventional antennas.

### DETAILED DESCRIPTION OF PREFERRED EMBODIMENTS

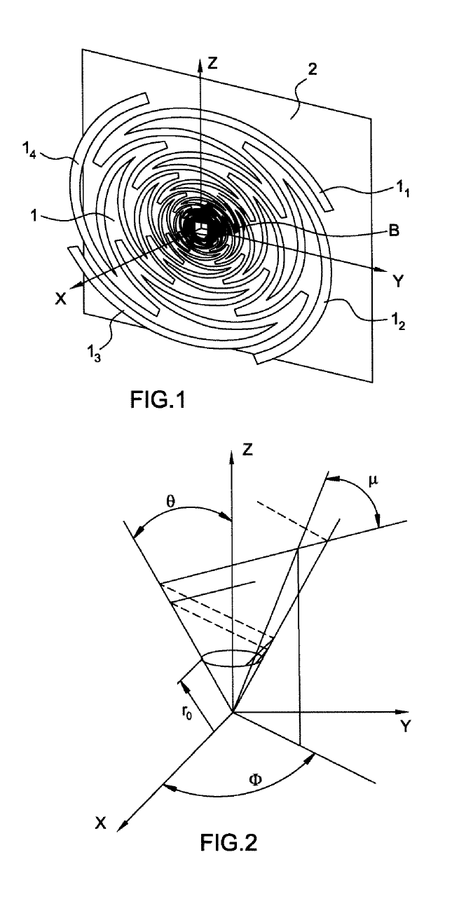

FIG. 1 represents an individual antenna 1 printed on a dielectric substrate including four complementary or self-complementary branches 1₁, 1₂, 1₃ and 1₄. This element 1 is arranged in front of a reflector 2 which notably makes it possible to make the antenna element 1 or individual antenna directional. The reflector 2 also has a protection function with respect to the spurious radiations originating from other antenna elements forming part of the array according to the invention. This reflecting plane notably makes it possible to obtain a better efficiency than when an absorbent cavity is used.

The geometry of an equi-angular spiral is defined by:

$${r}_{k} = {r}_{0} exp ( a ( Φ - \frac{2 π K}{N} ) )$$

r denoting the radius of an arm of the spiral and r₀ the radius at the center
where K represents the arm of the spiral concerned, N the number of arms and “a” the constant of the spiral with

$$a = \frac{sin ( θ )}{tan ( μ )}$$

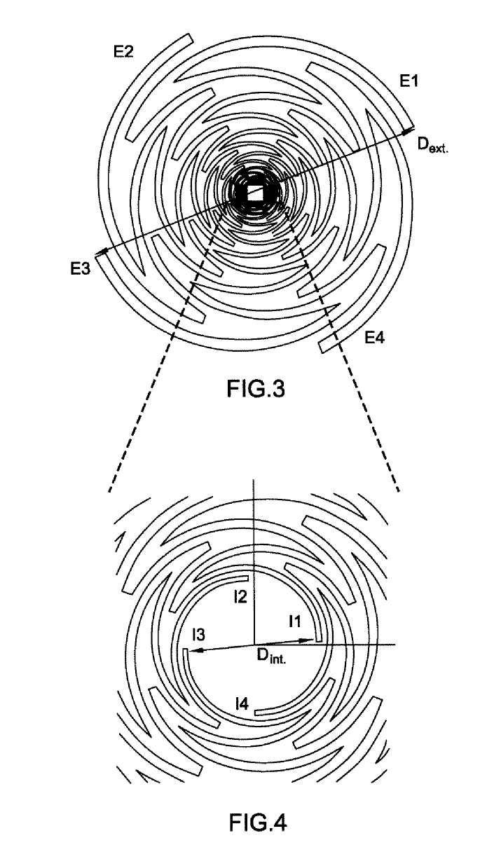

as defined in FIG. 2 in a polar coordinates diagram.

For a planar convoluted spiral,

$$θ = π / 2 and a = \frac{1}{tan ( μ )}$$

The excitation (center of the spiral) of the N arms takes place over a circle of radius r₀ that is small compared to the wavelength

$$( \frac{{d}_{0}}{λ} < 0.1 )$$

with d₀=2·r₀·sin(θ₀)=2·r₀. The length of each arm is defined by

$$L = ( r - {r}_{0} ) \cdot \frac{1}{cos ( μ )}$$

and the last important parameter for the spiral is the angular thickness defined by

$$δ = \frac{1}{a} Log ( \frac{sin ( μ ) + C}{sin ( μ ) - C} )$$

in which C is a constant that can be determined at the center of the spiral by R=Cr. The thickness of an arm is adjusted to the excitation (center of the spiral) by R₀=C·r₀. Basically, in a convoluted spiral, each arm is contained in an area defined by an angle α₀ and the external radius of this arm. Once the angle is determined, by making a simple “zigzag” in the clockwise then anticlockwise direction over α₀ degrees from the center, an arm of the spiral can be obtained.

The dimensions of a radiating element or individual antenna 1 are therefore determined by the external diameter Dₑₓₜ of the spiral which is proportional to the greatest wavelength λₘₐₓ, that is to say the lowest usage frequency Fₘᵢₙ. The diameter Dₑₓₜ corresponds to the diameter consisting of a circle passing through the outermost portions of the arms E₁, E₂, E₃, E₄, whereas the internal diameter Dᵢₙₜ of the spiral is defined from the innermost portions of the convoluted strands I₁, I₂, I₃, I₄ (FIGS. 3 and 4). By this log-periodic or quasi-log-periodic structure, the antenna is said to be frequency-independent.

The overall geometry of the antenna system (number and sizes of the individual antennas, dimensions of the antenna array) varies notably according to the frequency band to be processed, the carrier on which the antenna array is positioned and the direction-finding performance levels desired for a given application. The direction-finding accuracy is, for example, inversely proportional to the aperture of the array (distance between antennas) and is inversely proportional to the number of antennas used. On the other hand, the spacing between antennas must not be too great so as not to excessively increase the risks of ambiguity in the direction-finding accuracy. For example, a direction-finding antenna operating on the 20 MHz-160 MHz band with 5 dipoles arranged on a circle of radius 1.5 m has a good direction-finding accuracy.

The geometry of the antenna array may also be dependent on the carrier of the antenna array. It is, for example, selected in order to obtain an azimuth radiofrequency coverage equal or close to 360°. This configuration can, for example, be of circular type, arranged on the mast of a boat or even positioned on each face of a vehicle or linearly on the wings of an airplane.

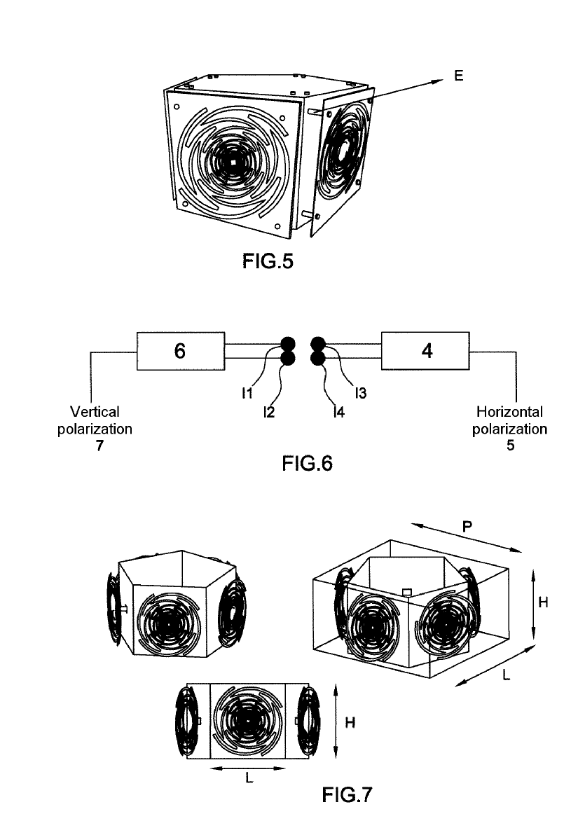

The individual antenna is secured to the reflector 2 by insulating spacers E (FIG. 5) of a length defined by the distance separating the antenna from the reflecting plane, as will be detailed hereinbelow.

FIG. 6 describes an embodiment in which 4 strands of an antenna are linked together in pairs via printed tracks for example, the strand 1₁ with the strand 1₃ (vertical polarization) and the strand 1₂ with the strand 1₄ (horizontal polarization). The strands that receive signals of the same polarization are linked to a matching device (balancing transformer) before being transmitted to signal processing and antenna processing devices. The function of this device, better known as a “balun”, is to balance the currents transmitted in the radiating elements and match the impedance of the antenna to the characteristic impedance of the receiver, ideally 50Ω. In FIG. 6, for example, a first impedance matching system (balancing transformer) 4 links the strands 1₂ and 1₄ and also provides matching relative to a signal processing system 5. The strands 1₁ and 1₃ are linked by a matching system 6 to a processing device 7 which will process the vertically-polarized signals received on each of the individual antennas forming the complete system so as to perform a direction-finding. Similarly, this device processes the horizontally-polarized signals.

The dimensioning of these matching devices depends on the frequency bands processed and on the desired matching performance levels. They are placed orthogonally to the antenna, between said antenna and the reflecting plane, at the excitation level.

Finally, in order to perform the direction-finding, the antenna system as described in FIG. 7 is associated with an antenna switch that is not represented in the figure which is used to select the individual radiating element and the successively selected polarization making it possible to acquire the different signals received on the antenna or the antenna system. All the signals acquired on the antennas will then be sent to a processing module which, by virtue of a direction-finding algorithm suited to the multiple polarization and a computer, will estimate the arrival angle of the signal regardless of its polarization. The signals are grouped together by polarization mode, the vertically-polarized signals being grouped together before being processed and the horizontally-polarized signals being grouped together before being processed. The system comprises a means for grouping the signals together according to their polarization, for example. The signals may, if necessary, be coupled at the output of each radiating element by a hybrid-type component. In this case, it is the direction-finding processing that will be adapted and that will be required to distinguish the polarization.

This direction-finding processing is notably based on the use of the amplitude and the phase of the signals.

In practice, unlike conventional methods that use only the amplitude or only the phase of the signals, the invention uses both quantities. This makes it possible to obtain rough information on the angle from the amplitude (sectorization) and accurate information from the phase, which significantly enhances the accuracy of the system.

As an example, an algorithm of vector correlation type, whether high resolution or not, using the amplitude and the phase of the signals will give better performance levels in the case of complex carrier structures.

### The Reflecting Plane 2

Intrinsically, the convoluted spiral has no directional radiation. To be able to obtain a directional antenna, there are a number of possible solutions. For example, it is possible to use an absorbent cavity as in the patent EP 0 198 578 or a square-shaped metal reflecting plane 2, placed behind the antenna 1, FIG. 1. The dimensions of the reflecting plane 2 are notably determined relative to those of the convoluted spiral that forms the antenna according to the invention and relative to the low usage frequency of the system. In practice, to be optimal, a reflecting plane must be at least of dimension λ for this frequency. The main advantage offered by the use of a reflecting plane is that it enhances the efficiency of the antenna compared to a solution using absorbent cavities. The distance, defined by the normal between the center of the antenna 1 and the reflecting plane 2, must be equal in the optimum case to a quarter wavelength for a particular frequency F. Consequently, the usage band of the antenna will be limited by the dimensions of the reflecting plane and its distance from the radiating elements. Since one of the main qualities of a directional antenna is that it has the best possible front-back ratio (directivity ratio between the front and the back of the antenna), the distance value is consequently selected in order to enable the antenna to operate over the widest possible frequency band while retaining a good front-back ratio in the radiation of the antenna. For example, if the established objective is to have the best front-back ratio for the frequency F1 of a usage frequency band, then the distance “d” between the reflecting plane 2 and the antenna is set by the formula:

$$d = \frac{C}{4 F 1} .$$

### Protection of the Matching Circuits

As explained above, the dimensions of the antenna depend on the targeted frequency band. The low frequency is proportional to the external diameter Dₑₓₜ of the spiral and the high frequency is proportional to the internal diameter Dᵢₙₜ of the spiral, so it is possible for the matching circuits to disturb the radiation of the antenna for the high usage frequencies. To remedy this, the matching circuit may include a metal shielding “B” in FIG. 1, which makes it possible to avoid the degradations that the “baluns” can provoke on the radiation of the antennas, regardless of the polarization.

### Association in an Array

FIG. 7 gives an exemplary embodiment of an array according to a regular polygonal configuration comprising 5 radiating elements. The duly formed pentagonal array notably offers the advantage of having an array of directional antennas that makes it possible to place this multiple-polarization antenna array on any carrier structure without being disturbed by the latter. It also makes it possible to work with a radiofrequency coverage of 360°. For example, it is possible to position it at the top of a mast as represented in FIG. 9. The dimensions of the array defined by the height H, the length L and width of the system P, depend on the size of the individual radiating element and on the frequency band and the expected performance levels.

As an example, the array of FIG. 9, operating on the 500 MHz-3000 MHz frequency band, has the following dimensions:

### P=420 mm, L=420 mm and H=250 mm.

The array is associated with a means, not represented in the figure, that makes it possible to execute the steps of the antenna processing algorithms capable of processing the multiple-polarization of the signals and working by taking into account the amplitude and the phase of the signals.

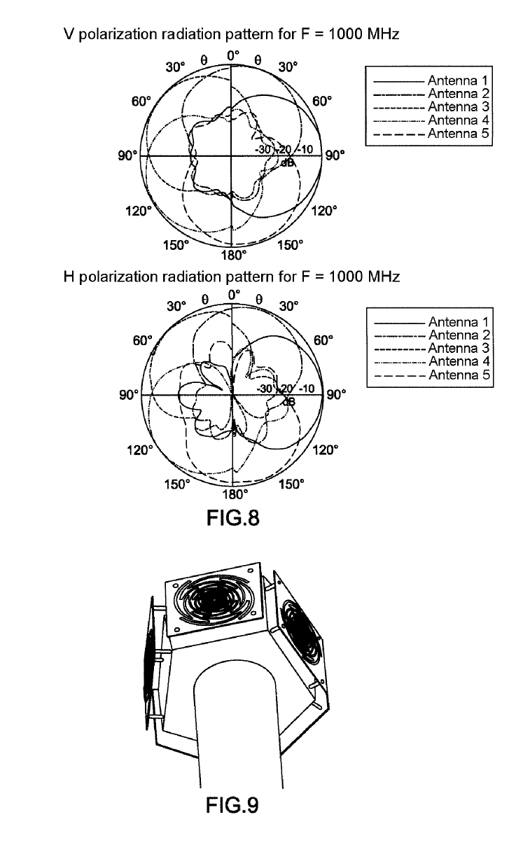

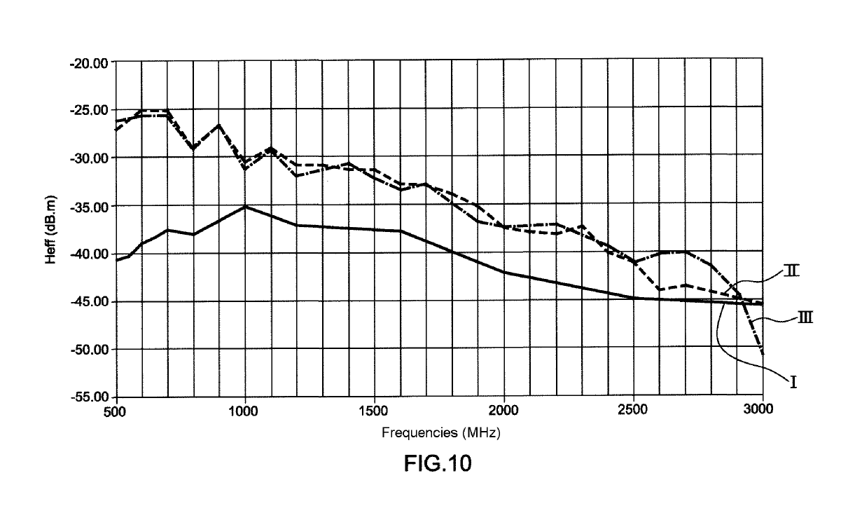

The radiation pattern of FIG. 8 shows a measurement result at 1 GHz from the antennas of the array described by the preceding example of the invention. These patterns were measured with a feed in linear, vertical and horizontal polarization modes and the responses from each antenna in the corresponding polarizations were measured. The 3 dB aperture is 75° which makes it possible, with a minimum of 5 convoluted spirals, to have a good coverage following all azimuths. By applying direction-finding algorithms based on the amplitude and the phase of the signals, of vector correlation type, or high resolution algorithms (MUSIC, CAPON, etc., known to those skilled in the art), excellent accuracy performance levels in both polarizations are obtained. Also, the greater the number of spirals, the higher the performance levels. These results remain valid over the entire usage frequency band of the antenna and regardless of the polarization.

Depending on the system on which the multiple-polarization direction-finding antenna array is used, the configuration of the network may differ: linear or homothetic array in the case of an airborne configuration.

In the context of use by a wide band direction-finding antenna system, more generally the implementation requires a structure including:
N antennas of convoluted spiral type, the dimensions of which are matched to the usage frequency band,
N metal reflecting planes of the same dimension as the individual antennas,
2N matching circuits (baluns),
N protections (shielding) to mitigate the presence of the matching circuits,
a direction-finding algorithm suited to the multiple-polarization processing and to the installation configuration.

FIG. 10 represents, in a diagram in which the X axis corresponds to the frequencies expressed in MHz and the Y axis represents the effective height of an antenna according to the prior art, curve I, and for an antenna according to the invention, curve II corresponding to the vertical polarization and curve III the horizontal polarization.

The directional multiple-polarization antenna array described hereinabove therefore makes it possible to process signals regardless of the polarization without being hampered by the carrier structure of the antenna. This therefore allows for simpler integration on a carrier. Also, the radiation patterns of the antennas (aperture, front-back ratio, etc.) make it possible to obtain good accuracy performance levels without being disturbed by the carrier structure.

The good stability of the antenna array also makes it possible to consider calibrations by simulation since the radiation patterns will be little disturbed by the carrier structure. The fact that the antenna is insensitive to the carrier structure therefore makes it possible to envisage interchangeability of the antenna from one carrier to another without requiring a complete recalibration.

Furthermore, the two outputs of each radiating element make it possible to directly and independently process the vertical and horizontal polarizations and any other type of polarization by suitable processing.

Using, for example, a pentagonal array consisting of these antennas, we can have a coverage over 360° to apply the direction-finding processing operations without being disturbed by the antenna-supporting elements. In certain configurations, this also makes it possible to simplify or even eliminate the calibration phases, since the individual antennas will not be affected by the carrier structure.

While there have been shown and described particular features of the invention as applied to preferred embodiments thereof, it will be understood that various omissions, substitutions, and changes in the form and details of the devices illustrated, and in their operation, may be made by those skilled in the art without departing from the spirit and scope of the invention.

1. A directional multiple-polarization wide band antenna array working in a selected frequency band comprising:
a plurality of N individual sensors of convoluted spiral type complementing a number of strands arranged according to a structure for obtaining a given azimuth coverage,
each of the N sensors comprising a reflecting plane attached to the antenna by an insulating spacer E,
each of the N sensors comprising matching cells suited to the working frequency band of said array,
each of the N sensors comprising separate output channels for vertically-polarized signals and for horizontally-polarized signals, and
a device suitable for executing a direction-finding algorithm that uses the amplitude and the phase of said signals and is matched to the configuration of the array.

2. The antenna array as claimed in claim 1, wherein each antenna element is associated with at least one shielded matching device.

3. The antenna array as claimed in claim 1, wherein the dimensions of the spirals are selected so as to work in a selected frequency band.

4. The antenna array as claimed in claim 1, wherein the shape of the antenna array is matched to the reflecting plane, said reflector being a flat, conical, cylindrical or conformal reflector.

5. The antenna array as claimed in claim 1, wherein the dimensions of the reflecting plane are selected according to the desired frequency band.

6. The antenna array as claimed in claim 1, wherein the antenna includes five antenna elements arranged in an array having a pentagonal shape.

7. The antenna array as claimed in claim 1, wherein the arrangement of the antennas is matched to the carrier of the antenna array such that it is possible to obtain an azimuth coverage substantially equal to 360°.

8. The antenna array as claimed in claim 1, wherein the antenna processing algorithm is suitable for processing the multiple-polarization of the signals and operating by taking into account the amplitude and the phase of the signals.

9. The antenna array as claimed in claim 1, further comprising a means for grouping together the signals having one and the same polarization, the groups including a group of vertically-polarized signals coming from the various individual sensors and a group of horizontally-polarized signals, the grouping means being arranged upstream of the device comprising the processing algorithm.

10. The antenna array as claimed in claim 1, wherein the direction-finding processing operation is suited to the geometry, to the electrical characteristics of the carrier and to the expected performance levels.

11. Use of the antenna array as claimed in claim 1 for direction-finding for signals received on the individual sensors.

12. The antenna array as claimed in claim 4, wherein the dimensions of the reflecting plane are selected according to the desired frequency band.

13. A method of using a directional multiple-polarization wide band antenna array working in a selected frequency band for direction-finding for signals received on individual sensors, the method comprising the following steps:
using a plurality of N individual sensors of convoluted spiral type complementing a number of strands arranged according to a structure for obtaining a given azimuth coverage, each of the N sensors comprising a reflecting plane attached to the antenna by an insulating spacer E, each of the N sensors comprising matching cells suited to the working frequency band of said array, and each of the N sensors comprising separate output channels for vertically-polarized signals and for horizontally-polarized signals, and
executing a direction-finding algorithm using the amplitude and phase of signals that is matched to the configuration of the array.
